(19) United States
(12) Patent Application Publication
(10) Pub. No.: US 2005/0083861 A1
(43) Pub. Date: Apr. 21, 2005

(54) Method and arrangement for converting a first data stream into a second data stream

(76) Inventors: Sebastiaan Antonius Fransiscus Arnoldus Van Den Heuvel, Eindhoven (NL); Mark Henricus Verberkt, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/506,282

(22) PCT Filed: Feb. 7, 2003
(86) PCT No.: PCT/IB03/00523

(30) Foreign Application Priority Data
Mar. 5, 2002 (EP) 020758454

(51) Int. Cl. H04L 5/14; H04N 7/173

(52) U.S. Cl. 370/294; 725/100

(57) ABSTRACT

Method and system for converting a first data stream (10) received from a network (12) into a second data stream (16) for delivery to an end terminal (18). The first data stream (10) has a first data rate, and comprises at least one data packet stream of a predetermined type. The system comprises a re-multiplexer (25) which is arranged for recovering the at least one data packet stream of the predetermined type from the first data stream (10). The re-multiplexer (25) is further arranged for re-multiplexing the at least one data packet stream using a predetermined bit rate to provide the second data stream (16) with a fixed bandwidth.

Method and arrangement for converting a first data stream into a second data stream The present invention relates to the field of converting one type of data stream to a second type of data stream. More specifically, the present invention relates to a method for converting a first data stream into a second data stream for delivery to an end terminal, the first data stream having a first data rate, and comprising at least one data packet stream of a predetermined type, the method comprising the step of recovering the at least one data packet stream of the predetermined type from the first data stream. In a second aspect, the present invention relates to a system for converting a first data stream received from a network into a second data stream for delivery to an end terminal, the first data stream having a first data rate, and comprising at least one data packet stream of a predetermined type, the system comprising a re-multiplexer which is arranged for recovering the at least one data packet stream of the predetermined type from the first data stream.

American patent application U.S. 2001/0009548 discloses a method and apparatus for converting data streams of a MPEG-2 transport stream into a MPEG-2 program stream. Only one partial transport stream (representing a single audio/video channel to be recorded or displayed) is converted into the MEG-2 program stream format. The MPEG-2 program stream is constructed from elementary data streams from the transport streams, e.g. audio and video data streams, and re-multiplexed to provide a correct program stream.

American patent application U.S. 2001/0008535 discloses a method and system to provide interconnection between audio and video devices. Re-multiplexing techniques are used to compensate for a decoding delay which may be caused when different hardware is used for decoding audio and video data. Video and audio data of a data stream are de-multiplexed, and a delay is applied to at least one of the video and audio data using buffers compensating for the processing latency from the video and audio destination devices.

Known methods and systems for converting data streams exhibit a number of disadvantages. Especially, when the input data stream is a MPEG-2 transport stream, the strict timing requirements will introduce a number of disadvantages when converting the transport stream. Null packets or unwanted packets in the MPEG-2 transport stream are removed which may lead to loss of timing information. This is solved in the known systems by time stamping the data packets when they are received from the access network. In the end terminal, the data may then be gated at the correct time. However, when the processing of incoming data is performed in a software implementation, time stamping may not be correct. Furthermore, the resulting data stream is no longer having a continuous fixed bandwidth, but a varying bandwidth. Known systems try to overcome this problem by using a smoothing buffer in the end terminals, but buffer dimensioning may lead to buffer overflow and thus loss of information.

The present invention seeks to provide a method and system for converting data streams which overcome the above mentioned disadvantages.

According to the present invention, a method for converting a first data stream into a second data stream is provided according to the preamble defined above, in which the method comprises the further step of re-multiplexing the at least one data packet stream using a predetermined bit rate to provide the second data stream with a fixed bandwidth. Using this method, no smoothing buffer is needed in the end terminal, as the second data stream has a fixed data rate matching the available data bandwidth for the second data stream to the end terminal. It also allows to include data streams other than standard data streams (e.g. as defined in IEC 61883) in the second data stream which is communicated to the end terminal.

In an embodiment of the present invention, the predetermined bit rate is synchronized with a bus cycle clock of the link for transporting the second data stream. This allows maintaining a good synchronization of the second data stream, and ensures a very robust data stream transfer.

In an exemplary embodiment of the present invention, the first data stream is an MPEG-2 transport stream and the second data stream is a partial transport stream within an IEEE1394 data stream. This is a very commonly used application in present day video systems.

It is still possible that the bandwidth for the second data stream is insufficient at certain moments in time for various reasons. This may be solved by a further embodiment, in which the first data stream comprises further data packets, the further data packets comprising non time critical information to be included in the second data stream, and the method comprises the further steps of detecting when the bandwidth is insufficient for delivering all desired data packets and temporarily storing or deleting the further data packets when bandwidth is insufficient. By temporarily holding the non-time critical data packets, and sending these at a later moment in time when sufficient bandwidth is available, correct data transfer to the end terminal may be preserved.

In a further alternative embodiment, the at least one data packet stream comprises multiple prioritized data packet streams, and the method comprises the further steps of detecting when the bandwidth is insufficient for delivering all desired data packets and temporarily storing or deleting the data packet streams with lower priority when bandwidth is insufficient. This allows preserving a good quality data transfer for at least the data packet stream with the higher priority. An example of such behavior could be removing one or more frames from the video stream while maintaining the integrity of the stream.

The present invention may also be applied when a bus reset takes place on the data transfer link to the end terminal. In this embodiment, the method comprises the further steps of detecting a bus reset, temporarily storing data packets after detecting a bus reset, and resuming the conversion of the first data packet stream to the second data packet stream directly after completion of the bus reset. This will allow bus resets to be handled without losing any data packet while maintaining a correct transport stream format (time stamp), thus having no visible effect on the video signal delivered to the end terminal.

In a further aspect, the present invention relates to a system as defined in the preamble defined above, in which the re-multiplexer is further arranged for re-multiplexing the at least one data packet stream using a predetermined bit rate to provide the second data stream with a fixed bandwidth. In an embodiment, the system comprises a time stamp unit connected to the re-multiplexer, the time stamp unit being arranged for time stamping data packets of the at least one data packet stream. The re-multiplexer and time stamp unit may be integrated in a single device, and these elements may be arranged to perform the functionality of the method according to the present invention.

The present invention will now be explained in further detail using an exemplary embodiment, with reference to the accompanying drawings, in which

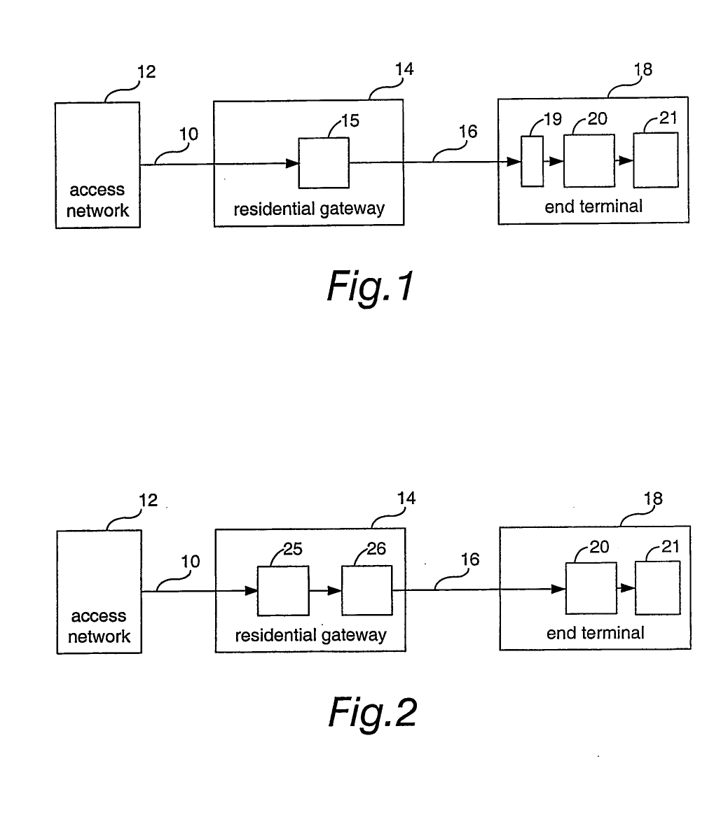

FIG. 1 shows a schematic view of a data stream conversion system according to a prior art embodiment; and

FIG. 2 shows a schematic view of a data stream conversion system according to an embodiment of the present invention.

In FIG. 1 a schematic view is shown of a MPEG-2 transport stream 10 which is received from an access network 12, such as a satellite network, by a residential gateway 14 and delivered to an end terminal 18 according to prior art systems. The residential gateway 14 is a device that transforms the MPEG-2 transport stream into a second type of data stream, such as a (partial) transport stream over IEEE1394 16. The (partial) transport stream 16 is sent to the end terminal 18, which e.g. will process the (partial) transport stream 16 for display. The (partial) transport stream will only comprise the data requested for the end terminal 18 for reasons of bandwidth efficiency.

Timing constraints of the MPEG-2 transport stream 10 are very strict, i.e. the level of jitter allowed between different packets in the stream 10 is very small. Usually, the MPEG-2 transport stream 10 received from the access network 12 will comprise null packets, i.e. packets containing no data at all. A data stream converter 15 in the residential gateway 14 will convert the data stream 10 e.g. in a partial) transport stream 16. The (partial) transport streams only comprise packets having actual data in them.

The conversion comprises removal of the null packets, and possibly removal of other data packets not required by the end terminal 18 (control data packets or further data stream packets, such as a different channel). After this, the data stream is no longer a continuous sequence of packets. The characteristic constant bandwidth of the MPEG-2 transport stream 10 changes into a variable bandwidth, and the timing of the packets in the data stream is no longer defined.

Real time behavior of the data packets in the data stream can be maintained by time stamping the packets in the stream by the data stream converter 15 (as defined in IEC 61883). The data stream converter 15 is arranged to generate a time stamp when the packet is received by the residential gateway 14 from the access network 12. This however requires that the transport stream packet be offered to the data stream converter 15 at exactly the correct time. This may be a problem when the processing of the incoming data stream 10 is implemented in software (and real time behavior of the data stream 16 may be lost, or even data packets may be lost).

After receiving the time stamped data packets of the IEEE1394 data stream 16, an end terminal processor 20 will provide the data packets to the further elements 21 at the (relative) time indicated by the time stamp of each data packet.

To allow for the variable bandwidth of the (partial) transport stream 16 received from the residential gateway 14, the end terminal 18 is provided with a smoothing buffer 19. The packets received are stored in the smoothing buffer 19 until the time step indicates the packet should be delivered. The size of the smoothing buffer 19 is calculated taking into account the MPEG-2 video encoding behavior of a partial transport stream comprising one single MPEG-2 video stream, according to the IEC 61883 standard. However, the data stream 16 may be non-standard (e.g. comprising more than one MPEG-2 video stream), which may lead to buffer overflow.

In FIG. 2, a schematic view is given of a MPEG-2 transport stream 10 being delivered from an access network 12 to an end terminal 18 according to the method and system of the present invention. In FIG. 2, elements having the same function as the elements in FIG. 1 are given the same reference numeral. The residential gateway 14 now comprises a re-multiplexer 25 and a time stamp unit 26 (sequentially as viewed from access network 12 to end terminal 18).

The re-multiplexer 25 is arranged for re-multiplexing the data packets requested by the end terminal 18, instead of simply deleting all null packets and other unwanted packets. The re-multiplexer 25 is arranged to deliver a data stream with a bit rate which is equal to one of the predefined bandwidths of the IEEE1394/IEC 61883 standards. The bandwidth is chosen to provide sufficient bandwidth to transport the desired IEEE1394 data stream 16 to the end terminal 18. Now, the re-multiplexed data stream is a continuous sequence of packets, without any gaps. As the data stream has a bit rate which exactly matches the available bandwidth on the IEEE1394 link, no smoothing buffer is needed in the end terminal 18. Thus, the problems identified above relating to the size of the smoothing buffer 19 (buffer overflow) will not occur.

The re-multiplexer 25 may be arranged to obtain real time behavior by using the IEEE1394 bus clock and the known transport stream bit rate. This ensures that the packets of the MPEG-2 transport stream 10 are delivered in time to the time stamp unit 26 and may be time stamped at the correct (relative) time.

For the person skilled in the art, it will be clear that the re-multiplexer 25 and time stamp unit 26 may be integrated and may form part of a general processing element, such as a IEEE1394 chipset.

In a typical application, the bandwidth of the transport stream 10 is 12.032 Mbit/s (corresponding to one transport stream data packet per bus cycle), and then the bus cycle clock can be used to ensure correct timing behavior.

As multiplexing the data packets is done before the time stamping, it is possible to delay non-time critical information in order to preserve the available bandwidth. It is also possible to stop certain data streams in favor of another stream or other streams, in order to preserve the quality of the other stream(s).

A further advantage occurs relating to bus resets. When a bus reset occurs (for whatever reason), packets need not be lost. The buffering as defined by IEC 61883 and present in the IEEE1394 chipset (formed by re-multiplexer 25 and time stamp unit 26) may be used to cope with the drop of streaming during a bus reset. Data transmission may be resumed immediately after a bus reset without losing any packet and maintaining a correct transport stream (time stamp) format. This will allow handling of bus resets without any visible effect of the displayed video.

For the person skilled in the art it will be clear that the above described embodiment is only an exemplary embodiment. Further modifications and amendments may be incorporated which fall within the scope of the invention as defined in the appended claims.

1. Method for converting a first data stream into a second data stream for delivery to an end terminal, the first data stream having a first data rate, and comprising at least one data packet stream of a predetermined type, the method comprising the steps of:
recovering the at least one data packet stream of the predetermined type from the first data stream,
re-multiplexing the at least one data packet stream using a predetermined bit rate to provide the second data stream with a fixed bandwidth, characterized in that the method comprises the further step of synchronizing the predetermined bit rate with a bus cycle clock of the link for transporting the second data stream.

2. Method according to claim 1, in which the first data stream is an MPEG-2 transport stream.

3. Method according to claim 1, in which the second data stream is a (partial) transport stream.

4. Method according to claim 1, in which the first data stream comprises further data packets, the further data packets comprising non time critical information to be included in the second data stream, and the method comprises the further steps of
detecting when the bandwidth is insufficient for delivering all desired data packets;
temporarily storing or deleting the further data packets when bandwidth is insufficient.

5. Method according to claim 1, in which the at least one data packet stream comprises multiple prioritized data packet streams, and the method comprises the further steps of
detecting when the bandwidth is insufficient for delivering all desired data packets;
temporarily storing or deleting the data packet streams with lower priority when bandwidth is insufficient.

6. Method according to claim 1, the method comprising the further steps of:
detecting a bus reset;
temporarily storing data packets after detecting a bus reset;
resuming the conversion of the first data packet stream to the second data packet stream directly after completion of the bus reset.

7. System for converting a first data stream (10) received from a network (12) into a second data stream (16) for delivery to an end terminal (18), the first data stream (10) having a first data rate, and comprising at least one data packet stream of a predetermined type, the system comprising a re-multiplexer (25) which is arranged for recovering the at least one data packet stream of the predetermined type from the first data stream (10), the re-multiplexer (25) being further arranged for re-multiplexing the at least one data packet stream using a predetermined bit rate to provide the second data stream (16) with a fixed bandwidth, characterized in that the system delivers the second data stream (16) to the end terminal (18) via a communication link, and in which the re-multiplexer (25) is further arranged to synchronize the predetermined bit rate with a bus cycle clock of the communication link.

8. System according to claim 7, in which the first data stream is an MPEG-2 transport stream.

9. System according to claim 7, in which the second data stream is a (partial) transport stream.

10. System according to claim 7, in which the system further comprises a time stamp unit (26) connected to the re-multiplexer (25), the time stamp unit (26) being arranged for time stamping data packets of the at least one data packet stream.

11. System according to claim 7, in which the first data stream comprises further data packets, the further data packets comprising non time critical information to be included in the second data stream, and the re-multiplexer (25) is further arranged for detecting when the bandwidth is insufficient for delivering all desired data packets and temporarily storing or deleting the further data packets when bandwidth is insufficient.

12. System according to claim 7, in which the at least one data packet stream comprises multiple prioritized data packet streams, and the re-multiplexer (25) is further arranged for detecting when the bandwidth is insufficient for delivering all desired data packets and temporarily storing or deleting the data packet streams with lower priority when bandwidth is insufficient.

13. System according to claim 1, the re-multiplexer (25) being further arranged for detecting a bus reset, temporarily storing data packets after detecting a bus reset, resuming the conversion of the first data packet stream (10) to the second data packet stream (16) directly after completion of the bus reset.
